(19) United States
(12) Patent Application Publication
(10) Pub. No.: US 2023/0350413 A1
(43) Pub. Date: Nov. 2, 2023

(54) CONTROL SYSTEM FOR AN UNMANNED AUTONOMOUS VEHICLE

(71) Applicant: CANON U.S.A., INC., Melville, NY (US)

(72) Inventor: Yuki ISHIDA, KOWLOON (HK)

(21) Appl. No.: 18/017,016

(22) PCT Filed: Jul. 19, 2021
(86) PCT No.: PCT/US2021/042184

§ 371 Date: Jan. 19, 2023

Related U.S. Application Data
(60) Provisional application No. 63/053,948, filed on Jul. 20, 2020.

(51) Int. Cl. G05D 1/00; G05D 1/10; B64U 10/13; G06V 40/16; G06V 20/17

(52) U.S. Cl. CPC G05D 1/0094; G05D 1/106; B64U 10/13; G06V 40/166; G06V 20/17; B64U 2201/10; B64U 2101/30

(57) ABSTRACT

An unmanned aerial vehicle controller is provided that includes one or more processors and one or more memories storing instructions that, when executed, configures the one or more processors, to set, based on received threshold information, at least a first threshold and a second threshold used to automatically drive an unmanned aerial vehicle during performance of a selfie function that captures at least one image using a camera mounted on the unmanned aerial vehicle, determine whether the unmanned aerial vehicle will be automatically driven using the first threshold or the second threshold, and cause the unmanned aerial vehicle to be automatically driven and perform the selfie function using the determined threshold among at least the first and second thresholds.

### CROSS-REFERENCE TO RELATED APPLICATIONS

This PCT application claims the benefit of priority from U.S. Provisional Patent Application Ser. No. 63/053,948 filed on Jul. 20, 2020, the entirety of which is incorporated by reference herein.

### BACKGROUND

### Field

The present disclosure relates generally to an unmanned autonomous vehicle and method for controlling the vehicle to capture images.

### Description of Related Art

Unmanned autonomous vehicles, otherwise known as drones, are known in the art. For consumer use these vehicles are of a size that allows them to be portable and be remotely controlled by a control device. In some instances, these vehicles can be controlled by a dedicated remote control device. In other instances, these vehicles may be controlled by a personal computing device such as a smartphone whereby a user ca control the position and movement of the vehicle by interacting with the screen of the smartphone such that the movement of the drone follows a path defined by the finger of the user as it moves across the screen of the smartphone. These vehicles are also known to include image capturing devices that can be controllable to capture images during flight. However, there are certain environmental conditions that make it difficult to ensure that the unmanned vehicle returns to the point of origin.

### SUMMARY

According to an aspect of the disclosure, an unmanned aerial vehicle controller is provided that includes one or more processors and one or more memories storing instructions that, when executed, configures the one or more processors, to set, based on received threshold information, at least a first threshold and a second threshold used to automatically drive an unmanned aerial vehicle during performance of a selfie function that captures at least one image using a camera mounted on the unmanned aerial vehicle, determine whether the unmanned aerial vehicle will be automatically driven using the first threshold or the second threshold, and cause the unmanned aerial vehicle to be automatically driven and perform the selfie function using the determined threshold among at least the first and second thresholds.

In one embodiment, the first and second thresholds are thresholds representing a distance between the user and the unmanned aerial vehicle, and the automatic driving is performed such that the unmanned aerial vehicle is less than a predetermined distance from the user represented by the threshold determined to use among the first and second thresholds. The first and second thresholds include distance information representing a distance between the user and the unmanned aerial vehicle and are detected by a sensor mounted on the unmanned aerial vehicle. In the embodiment, the controller is configured to detect a face of the user from a captured image by the camera, and the automatic driving of the unmanned aerial vehicle is performed based on the face of the user detected from the captured image.

In another embodiment, the threshold information represents a remaining battery life of the unmanned aerial vehicle, and wherein the automatic driving of the unmanned aerial vehicle is performed such that the selfie function is terminated when the remaining battery is less than a threshold determined to use among the first and second thresholds.

In a further embodiment, the threshold information represents an amount of shake in an image captured by the unmanned aerial vehicle, and the automatic driving of the unmanned aerial vehicle is performed such that the selfie function is terminated when the amount of shake is larger than a threshold determined to use from among the first and second thresholds.

In another embodiment, the threshold information represents a flying height of the unmanned aerial vehicle, and the automatic driving of the unmanned aerial vehicle is performed such that the unmanned aerial vehicle flies lower than a threshold determined to be used from among the first and second thresholds.

Another embodiment provides that the determination on the first and second thresholds is made based on user operations. Alternatively, the determination on the first and second thresholds is made based on a captured image by the camera and a determination to switch from a mode in which the first threshold is used to a mode in which the second threshold is used is made, when the user within the captured image captured during the selfie function is out of focus for a predetermined period of time.

In a further embodiment, the determination to switch from a mode in which the first threshold is used to a mode in which the second threshold is used is made, when the drone does not move to an expected position within a predetermined period of time after starting the automatic driving for the selfie function.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is a block diagram illustrating the hardware components of a control device that controls an unmanned autonomous vehicle.

FIG. 2 is a block diagram illustrating the hardware components of an unmanned autonomous vehicle.

FIG. 3 illustrates a calculation algorithm performed in conjunction with controlling an unmanned autonomous vehicle.

FIG. 4A is a flow diagram detailing an exemplary control algorithm for controlling the operation of an unmanned autonomous vehicle.

FIG. 4B is an illustration of the control performed when executing the algorithm in FIG. 4A.

FIG. 5A is a flow diagram detailing an exemplary control algorithm for controlling the operation of an unmanned autonomous vehicle.

FIG. 5B is an illustration of the control performed when executing the algorithm in FIG. 4A.

FIG. 6 is a flow diagram detailing an exemplary control algorithm for controlling the operation of an unmanned autonomous vehicle.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

According to aspects of the disclosure, the above drawbacks are remedied by the unmanned autonomous vehicle (UAV) described hereinafter. Throughout the following description, the UAV may also be referred to simply as a vehicle. In one embodiment, the UAV may be a drone that includes one or more propulsion devices that propel the drone along a particular flight path. The UAV described herein is operable to follow predetermined flight paths.

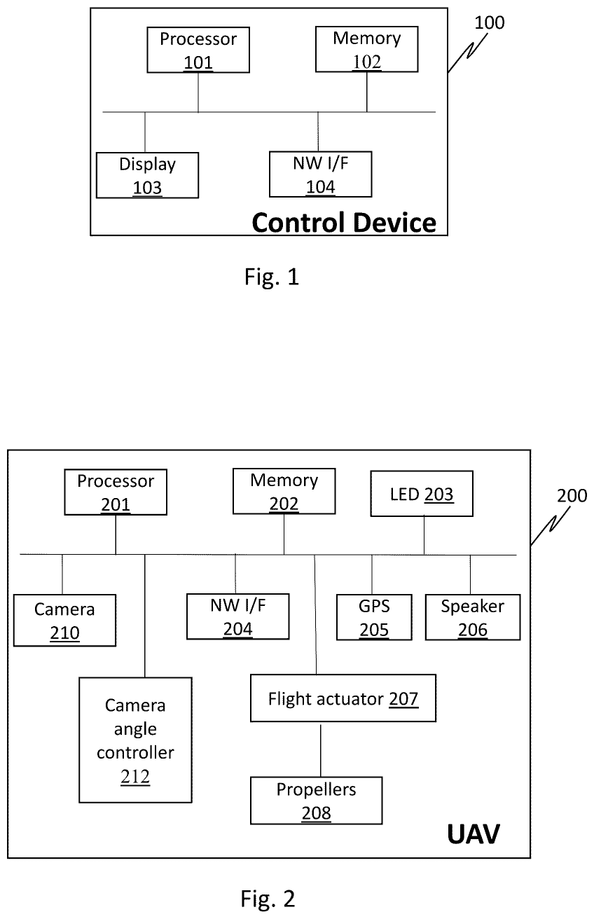

FIGS. 1 and 2 are block diagrams illustrating the hardware for controlling the operation of the control device 100 and UAV 200, respectively. Each of the control device 100 and the UAV 200 include at least one processor or CPU (101, 201) and one or more memories (102, 202) which store instructions that are executed by the one or more processors to control the respective device to perform is described operations. The one or more memories (102, 202) may include one or more RAMs and/or ROMS. For example, an electrically erasable programmable read-only memory (EEPROM). In the ROM, control programs and instructions that are executed by the processor are stored. Such programs are programs, when executed by one or more of the processors, cause the one or more processors to perform the operations and/or functions in the various flowcharts described hereinabove. The one or more memories also include random-access memory (RAM) is used as a system memory which operate as a work area for the data associated with execution of the control programs by the one or more processors. As part of the processors (101,201), a system timer may be included which measures the time for various controls and the time of a built-in clock. Each of the control device 100 and UAV 200 includes a network connection interface (104, 204) which allows for communication via local area network and/or wide area network. The communication facilitated by the network connection interface may include wired communication such as by Ethernet cable connection and/or wireless communication including short and long distance wireless communication such as Wi-Fi®, Bluetooth®, NFC and the like.

The control device 100 also includes a display 104 (e.g. operation panel) which is preferably touch sensitive such that touch operations can be translated into electrical signals to generate control commands. The display selectively displays one or more graphical user interfaces (GUI) generated by the one or more applications executing on the control device 100 and provide the user with the ability to selectively interact with and control the UAV 200 by selecting image elements that are translated into commands which are transmitted from the network interface 104 of the control device 100 and received by the network interface 204 of the UAV 200 and used to control operations of the UAV 200.

As shown in FIG. 2, in addition to the above common type components, the UAV 200 includes at least one indicator for providing a notification to a user. As shown herein, the at least one indicator includes at least one LED light 203 that can be selectively illuminated, a pattern or color of which provides information to a user, and a speaker 206 for audibly outputting a notification to a user. In some embodiments, the LED 203 and/or speaker 206 may be caused to output information by one or more programs executing on the UAV 200 at a given time. In some instances, the indicators provide information about the UAV 200 itself including operation and status information. In other instances, the indicators may provide information about one or more control signals received from the control device 100 and warn a user as to an upcoming action of the UAV 200. A GPS unit 205 is further provided that is able to obtain GPS coordinate data for the UAV 200 to determine and modify its position based thereon. A flight actuator 207 is provided which selectively controls one or more propulsion devices 208 (e.g. propellers) to rotate at a given speed and shift direction in order to cause the UAV 200 to move in a particular direction as described above. The UAV 200 also includes a camera angle controller 212 that controls an angular position of the image capture device 210 (e.g. camera) of the UAV so that images can be captured thereby and transmitted back to the control device via the network interface of the UAV.

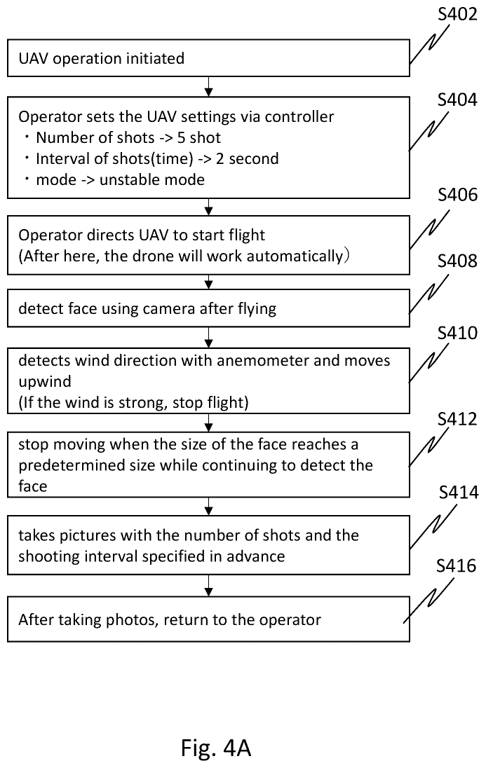

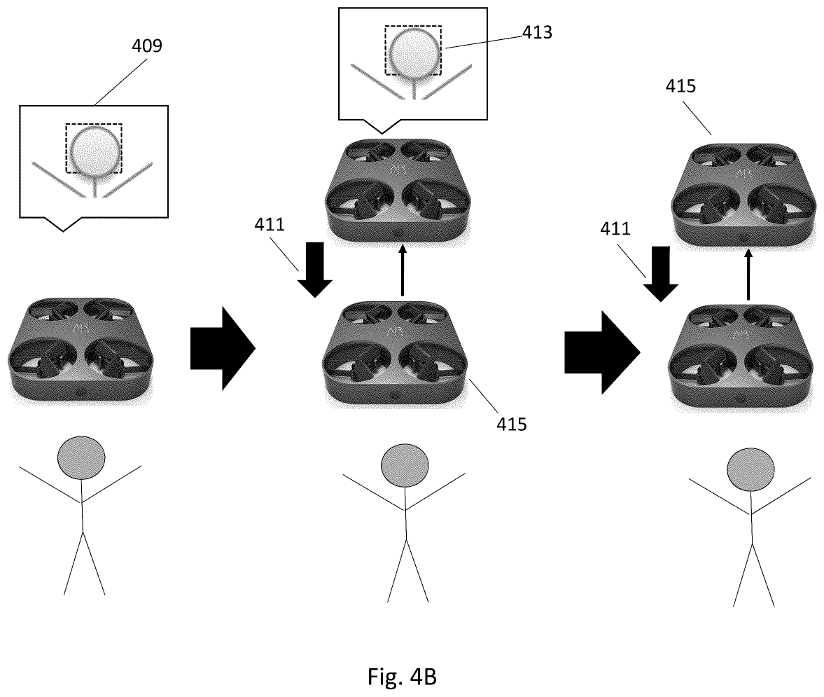

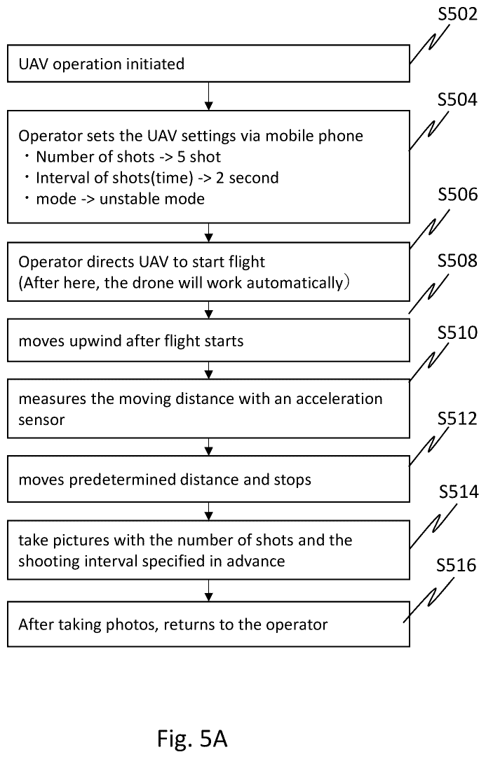

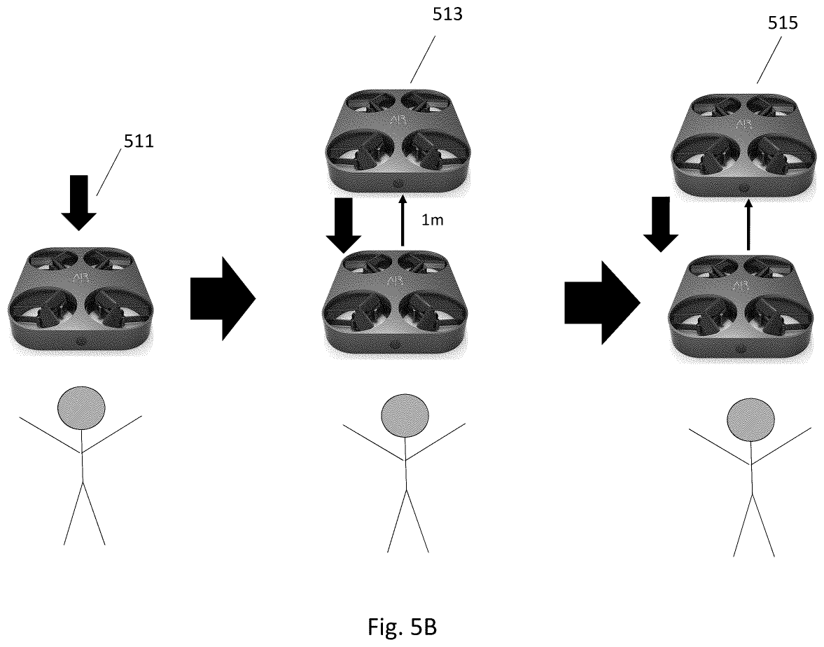

According to the present disclosure, the controller 201 (e.g. the processor that executes control instructions) for the unmanned aerial vehicle includes a mode of operation whereby the UAV 200 returns to an origination point (e.g. location where the operator launches the UAV) without regard to the environmental conditions during flight. For example, despite the presence of an undesirable amount of wind, the configured mode of operation successfully enables a return to the operator. The UAV 200 includes at least one image capture devices (e.g. cameras) 210 that captures one or more images from a forward perspective as the UAV 200 is flying in a particular flight direction. The UAV 200 may also include other cameras 210 or image capture devices on any side of the UAV 200 in order to capture images and perform control operations based on a particular image or series of images captures from any individual or a plurality of image capture devices 210. In some instances the camera angular controller 212 may be caused to maneuver and change position of the one or more image capture devices 210 to obtain these images from various directions and angles during flight. The controller 201 of the UAV 200 analyzes the images captured by the one or more image capture devices 210 to perform face detection which detects one or more faces present in one or more captured images as shown in FIGS. 4B and 5B. The results of the face detection operation may provide one or more input parameters that may be used in controlling the operation of the UAV 200. The UAV 200 also includes, as part of the flight actuator 207, one or more gyroscopic sensors which are used to measure the position and posture of the UAV 200 during operation. An accelerometer is provided and detects moving distance and speed. The UAV 200 is controlled to operate in at least two modes whereby one mode is a normal mode and a second mode is an unstable flight mode. Each of the modes includes a separate threshold value which governs operation while operating in the particular mode. When operating in the unstable flight mode, the controller 200 controls the propulsion devices 208, via the flight actuator 207, to maintain a distance between the operator and the UAV 200 that is within a predetermined distance by using the acceleration sensor. During this mode of operation the threshold information is set to represent a distance to be maintained between the operator and the UAV 200 such that the distance value set in unstable flight mode is less than a distance value set for operation during normal mode. Distance between the UAV 200 and the operator can be measured using the following formula:

Distance→(differential)→Velocity→(differential)→Acceleration

Distance←(Integral)←Velocity←(Integral)←Acceleration

In doing so, the distance is calculated by integrating acceleration twice along with the direction detection performed by the accelerometer which allows for the calculation of a distance between the operator using a control device 100 and the UAV 200. In one exemplary embodiment, the predetermined distance in normal mode is nine feet whereas the distance value for the unstable flight mode is three feet. In exemplary operation, prior to flight control being issued from the control device 100, threshold information including the thresholds for each of the normal and unstable flight modes are set by a user via input received at the display 103 of the control device 100 and transmitted from the network for receipt by the controller of the UAV.

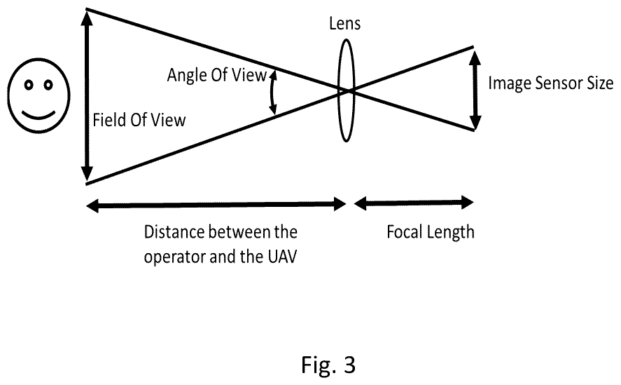

In certain embodiments, as illustrated in FIG. 3, the maintenance of distance according to the predetermined distance may be performed by using the face detection operation on the images being captured in real time to measure a size of the one or more faces in the captured images. A determination that the image contains one or more face sizes at a predetermined face size is measured to maintain the distance between the operator and the UAV. Generally, the angle of view is calculated from the size and focal length of the image sensor of the camera. Field of view is calculated from the detected face size. Distance between the operator and the UAV can be calculated from field of view and angle of view using trigonometric functions. In unstable flight mode the threshold value for face size in unstable flight mode is larger an a face size in normal operational mode.

In another embodiment, the threshold values for the operational modes may represent a predetermined time during with the UAV 200 is unable to move from a current position, for example, if there is strong wind, the UAV 200 may be unable to move along its predetermined flight path. In this operation, when the UAV 200 flies upwind, a gyroscope can sense the position of the UAV 200 such that, if it is determined that the UAV 200 Initially the UAV 200 flies upwind so that it can be easily returned to the operator. If the UAV 200 first moves leeward, it will slow down when returning to the operator. If the UAV 200 detects sway above a preset threshold using a gyro sensor, the UAV 200 is controlled to return to the operator. In another embodiment, if the flight upwind by the UAV 200 is being measured by an anemometer, if the UAV 200 cannot move for a predetermined time (due to wind), the UAV 200 is controlled to return to the origination point (e.g. the operator). In this embodiment, the threshold values for the first mode (e.g. normal mode) and second mode (e.g. unstable flight mode) represent time values that are used to determine whether the UAV 200 is moving as intended or whether there is an environmental impediment such as high wind preventing normal operation. In other embodiments, the threshold values represent a predetermined amount of face blur detected in an image capture. This may include detecting focus on the face in a captured image or random, significant or unpredictable movement of the face in the captured image. In normal operation the threshold value would be low amount of blur or low levels of movement between successive image frames whereas in unstable flight mode, the threshold value would represent a higher degree of motion between successive image frames. The face size detection may be performed by calculating a field of view by fixing the focal length and sensor size such that the field of view of is calculated based on a size of the face in the field of view as shown in FIG. 3. A further embodiment includes threshold values representing a UAV 200 battery level such that when the battery level drops below a threshold, the UAV 200 is controlled to return to the operator.

The UAV 200 may also automatically switch between the normal mode and unstable flight mode depending on conditions detected during flight. For example, if a strong wind blows, the UAV 200 will shake and tilt. The accelerometer detects the shake and determines whether a current operation mode should be changed to a different operation mode such as unstable flight mode. In one exemplary embodiment, if the accelerometer detects that the UAV 200 has moved up and down a predetermined number of times, the controller automatically configures the UAV 200 to enter unstable flight mode and the UAV 200 uses the threshold set for unstable flight mode to automatically drive its movement and return to the operator.

The number of thresholds is not limited to two (first threshold and second threshold), and three or more thresholds may be applied to the UAV 200. In a case where there are three thresholds, a first threshold (e.g. 9 feet) is used in normal mode, a second threshold (e.g. 4 feet) is used in intermediate mode, and a third threshold (e.g. 3 feet) is used in unstable flight mode.

In another embodiment, a selfie function may entered upon receiving a command from the control device 100 and causes the UAV 200 to move into position to capturing the operator and any persons immediately adjacent thereto. Also, the selfie function may be used for capturing one or more other specific objects. For example, the operator, using the control device 100, designates one or more specific objects as capturing targets by capturing them using the camera 210 mounted on the UAV 200 so that the UAV 200 captures these objects in variety of angles while the UAV 200 flies around them. This is further enabled by the controller 201 of the UAV 200 controlling the camera angle controller 212 to cause the camera 210 to be in the proper position to capture to identified targets.

In another embodiment, the UAV 200 may automatically switch the operation mode from normal mode to unstable flight mode when the UAV 200 detects specific objects such as swimming pool, sea, beach, river, cliff or wall within a predetermined distance (e.g. 4 feet) from the UAV 200. These objects can be detected by image recognition process performed by the UAV as discussed above.

In other embodiments, when the UAV 200 is performing a selfie function which means the capture of an image that may or may not include the operator, depending on the detected environmental condition, the controller causes the selfie function to end. For example, when the UAV 200 is moving towards a target position at which image capture is to be performed and an environmental condition causes the UAV 200 to move to a different, non-target position, and the accelerometer, gyroscope or anemometer detects the positional change, the controller causes the propulsion device to move the UAV 200 back to the target position. If this continued change and reposition occurs a predetermined number of times as defined by a threshold value, the controller causes the UAV to switch to unstable flight mode and uses the threshold parameter set by the user for the unstable flight mode to control operation such that the UAV 200 returns to the operator.

FIGS. 4-6 represent different operational embodiments as noted below which describe the automatic driver of the UAV configured and controlled by the controller along with the selfie function which captures one or more images from an onboard image capture device.

FIGS. 4A and 4B depict an exemplary embodiment of the mode control algorithm executing on the UAV 200. In step S402, initiation of the UAV 200 to be powered up is performed. In step S404, a control instruction is generated by the control device 100. The control device 100 receives an instruction from a user to cause the UAV to begin to operate in one of the first and second operation modes. The instruction is communicated to from the control device 100 to the UAV 200 which processes the instruction to control the flight actuator 207 to cause the propulsion device 209 to rotate and initiate flight. In step S404, a user inputs one or more control parameters via the display 103 of the control device 100. This includes parameters setting a number of images to be captured in a single image capture operation performed by the UAV and a duration between successive images to be captured during an image capture operation. Also included is a mode setting that sets the UAV 200 to operate in one of the first or second mode. In step S406, the control device transmits a start signal to the UAV to begin operation based on the control instruction transmitted in S404. It should be understood that steps S402-S406 are described as separate operations for purposes of example only and any of these steps may be performed together such as by a single control operation or selection of a preset instruction from a user interface displayed on the display 103 of the control device. After the start signal is transmitted to and received by the UAV 200, the operations described herein will be performed by one or more control programs executing on the UAV 200.

In step S408, the UAV is controlled, based on the control instruction of S404, to fly and perform a face detection operation to detect the face of the user. This is merely exemplary and, as discussed above, the detection operation may detect one or more faces and/or a preset object. This operation is illustrated by 409 shown in FIG. 4B. Therein, the UAV 200 is caused to fly at a predetermined path to remain in a desired position where face detection can be performed. In this operation, the initial detection determines a relative size of a face within a captured field of view. It should be noted that, if the UAV cannot perform face detection, the UAV 200 will automatically return to its origin position. Further, if the images being captured result in a predetermined amount of shake or motion occurring, the UAV 200 will also return to the origin point.

In step S410, the UAV 200 detects a wind direction using the onboard anemometer and control is performed such that the UAV 200 flies in a direction towards the wind (411 in FIG. 4B) and continues to capture images to determine whether a detected face has a relative size in the field of view equal that is set as part of the image capture operation as in 413 in FIG. 4B. In step S412, the UAV 200 stops moving and maintains its current flight position and path to maintain the detected face at the predetermined size relative to the entire field of view and continues to detect the face within the field of view. In one embodiment, the mode setting parameter in S404 sets the predetermined size relative to the entire field of view for face detection. In one embodiment, the first mode of operation may indicate that the detected face need only be 10% of the field of view whereas the second mode of operation indicates that the detected face need only 20% of the field of view. In the second (e.g. unstable) mode, the UAV 200 is advantageously controlled to fly into the direction of the wind to capture a larger face image to minimize distortion and improve focus for the resulting image. Once the face is detected at the predetermined size, in step S414, still image capture operations are performed based on the image capture parameters set in S404. This includes, for example, capturing the set number of images with a defined time between each captured image. This is merely exemplary and any image capture parameter may be specified and set in S404. In step S416, the UAV 200 is controlled to fly back to the origin position as shown in 415 in FIG. 4B

FIGS. 5A and 5B depict an exemplary embodiment of the mode control algorithm executing on the UAV 200. Steps S502-S506 are substantially similar to those described with respect steps S402-S406 in FIG. 4A and those descriptions are incorporated herein by reference and need not be repeated. In Step S508, the UAV when it begins flight and, in a case where it encounters wind, detects a direction of the wind using the anemometer. The UAV 200 is caused to move from its initial hovering position to an direction based on the force of the wind and, in step S510, uses its accelerometer to measure a distance that the UAV was caused to move by the wind. Steps S508 and S510 are shown in 511 in FIG. 5B. In step S512, the UAV 200 moves to a predetermined distance away from the operator as set in the control instruction provided in S504 based on the mode set by the user. In one embodiment, if the mode is the first mode, the UAV is caused to move a first distance that is further from the operator as compared to a distance associated with a second mode. For example, the predetermined distance may be 3 meters when the mode is set as the normal mode and 1 meter when the mode is set to unstable mode prior to flight. In another embodiment, based on the detection in steps S508 and S510, the controller 201 of the UAV can automatically override the mode set in S504 when the movement and wind detected are above certain thresholds. This advantageously allows for the UAV 200 to be in the best position to obtain images of the target such that the UAV 200 is closer to the user when the detected movement and wind indicates that the UAV 200 should fly in unstable mode. Steps S514 and S516 are substantially similar to those described above in S414 and S416. As such, their description is incorporated herein by reference and need not be repeated. It should be noted that execution of steps S514 and S516 are illustrated in 515 shown in FIG. 5B.

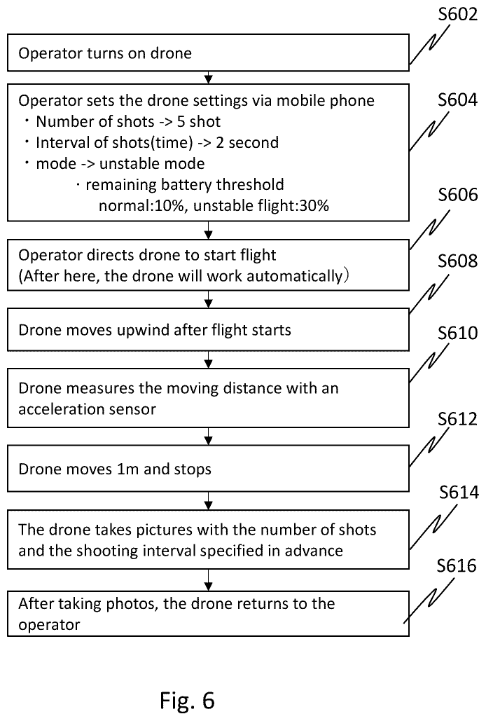

FIG. 6 depict an exemplary embodiment of the mode control algorithm executing on the UAV 200 that is similar to the embodiment described with respect to FIG. 5A. More specifically, steps S602-S616 in FIG. 6 correspond to S502-S516 in FIG. 5A and are incorporated herein by reference. The following will detail the specific differences in FIG. 6 as compared to FIG. 5A.

In S604, the control instruction includes power level parameter which, when received by the UAV 200, sets a battery level threshold. The battery level threshold detects an amount of power remaining in the battery of the UAV and, when the power level is determined to be below the threshold causes the UAV 200 to return to the origin position. Depending on the mode set, the power threshold level is different. For instance, if the set mode is the second mode, then the power threshold is higher (e.g. 30% battery life) as compared to the power threshold in the first mode (e.g. 10% battery life). This advantageously ensure that the UAV will have enough battery to drive the propulsion device to return to the origin point in view of the current environmental conditions such as strong wind or, in a case where the image capture operation captures an image indicating that the UAV is positioned over and around a hazard such a body of water or cliff. This advantageously minimizes the chance that the UAV will lose power before returning to the origin position potentially causing damage to the UAV. Furthermore, the power level parameter advantageously enables the controller 201 to periodically check power levels during steps S606-S616 to ensure that the UAV 200 returns to the position of origin and does not run out of power to do so. In another embodiment, in a case where the set mode is changed to a different mode, the periodic evaluation of the power level causes the controller 201 to control the propulsion devices 209 to return to the position of origin so that the UAV 200 does not unexpectedly run out of power when environmental conditions or environmental locations change during flight.

Aspects of the present disclosure can also be realized by a computer of a system or apparatus (or devices such as a CPU, a micro processing unit (MPU), or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a non-transitory computer-readable medium).

While the present disclosure has been described with reference to exemplary embodiments, it is to be understood that the disclosure is not limited to the disclosed exemplary embodiments.

We claim:

1. An unmanned aerial vehicle controller comprising:
one or more processors; and
one or more memories storing instructions that, when executed, configures the one or more processors, to:
set, based on received threshold information, at least a first threshold and a second threshold used to automatically drive an unmanned aerial vehicle during performance of a selfie function that captures at least one image using a camera mounted on the unmanned aerial vehicle;
determine whether the unmanned aerial vehicle will be automatically driven using the first threshold or the second threshold; and
cause the unmanned aerial vehicle to be automatically driven and perform the selfie function using the determined threshold among at least the first and second thresholds.

2. The unmanned aerial vehicle controller according to claim 1, wherein the first and second thresholds are thresholds representing a distance between the user and the unmanned aerial vehicle, and the automatic driving is performed such that the unmanned aerial vehicle is less than a predetermined distance from the user represented by the threshold determined to use among the first and second thresholds.

3. The unmanned aerial vehicle controller according to claim 2, wherein the first and second thresholds include distance information representing a distance between the user and the unmanned aerial vehicle and are detected by a sensor mounted on the unmanned aerial vehicle.

4. The unmanned aerial vehicle controller according to claim 2, wherein execution of the instructions further configures the one or more processors to
detect a face of the user from a captured image by the camera, and
wherein the automatic driving of the unmanned aerial vehicle is performed based on the face of the user detected from the captured image.

5. The unmanned aerial vehicle controller according to claim 1, wherein the threshold information represents a remaining battery life of the unmanned aerial vehicle, and wherein the automatic driving of the unmanned aerial vehicle is performed such that the selfie function is terminated when the remaining battery is less than a threshold determined to use among the first and second thresholds.

6. The unmanned aerial vehicle controller according to claim 1, wherein the threshold information represents an amount of shake in an image captured by the unmanned aerial vehicle, and wherein the automatic driving of the unmanned aerial vehicle is performed such that the selfie function is terminated when the amount of shake is larger than a threshold determined to use from among the first and second thresholds.

7. The unmanned aerial vehicle controller according to claim 1, wherein the threshold information represents a flying height of the unmanned aerial vehicle, and wherein the automatic driving of the unmanned aerial vehicle is performed such that the unmanned aerial vehicle flies lower than a threshold determined to be used from among the first and second thresholds.

8. The unmanned aerial vehicle controller according to claim 1, wherein the determination on the first and second thresholds is made based on user operations.

9. The unmanned aerial vehicle controller according to claim 1, wherein the determination on the first and second thresholds is made based on a captured image by the camera.

10. The unmanned aerial vehicle controller according to claim 9, wherein determination to switch from a mode in which the first threshold is used to a mode in which the second threshold is used is made, when the user within the captured image captured during the selfie function is out of focus for a predetermined period of time.

11. The unmanned aerial vehicle controller according to claim 1, wherein determination to switch from a mode in which the first threshold is used to a mode in which the second threshold is used is made, when the drone does not move to an expected position within a predetermined period of time after starting the automatic driving for the selfie function.

12. A method of controlling an unmanned aerial vehicle comprising:
setting, by a controller based on received threshold information, at least a first threshold and a second threshold used to automatically drive an unmanned aerial vehicle during performance of a selfie function that captures at least one image using a camera mounted on the unmanned aerial vehicle;
determining, by the controller, whether the unmanned aerial vehicle will be automatically driven using the first threshold or the second threshold; and
causing the unmanned aerial vehicle to be automatically driven and perform the selfie function using the determined threshold among at least the first and second thresholds.

13. The unmanned aerial vehicle controller according to claim 12, wherein the first and second thresholds are thresholds representing a distance between the user and the unmanned aerial vehicle, and the automatic driving is performed such that the unmanned aerial vehicle is less than a predetermined distance from the user represented by the threshold determined to use among the first and second thresholds.

14. The unmanned aerial vehicle controller according to claim 13, wherein the first and second thresholds include distance information representing a distance between the user and the unmanned aerial vehicle and are detected by a sensor mounted on the unmanned aerial vehicle.

15. The unmanned aerial vehicle controller according to claim 13, further comprising:
detecting, by the controller, a face of the user from a captured image by the camera, and
wherein the automatic driving of the unmanned aerial vehicle is performed based on the face of the user detected from the captured image.

16. The unmanned aerial vehicle controller according to claim 12, wherein the threshold information represents a remaining battery life of the unmanned aerial vehicle, and wherein the automatic driving of the unmanned aerial vehicle is performed such that the selfie function is terminated when the remaining battery is less than a threshold determined to use among the first and second thresholds.

17. The unmanned aerial vehicle controller according to claim 12, wherein the threshold information represents an amount of shake in an image captured by the unmanned aerial vehicle, and wherein the automatic driving of the unmanned aerial vehicle is performed such that the selfie function is terminated when the amount of shake is larger than a threshold determined to use from among the first and second thresholds.

18. The unmanned aerial vehicle controller according to claim 12, wherein the threshold information represents a flying height of the unmanned aerial vehicle, and wherein the automatic driving of the unmanned aerial vehicle is performed such that the unmanned aerial vehicle flies lower than a threshold determined to be used from among the first and second thresholds.

19. The unmanned aerial vehicle controller according to claim 12, wherein the determination on the first and second thresholds is made based on user operations.

20. The unmanned aerial vehicle controller according to claim 12, wherein the determination on the first and second thresholds is made based on a captured image by the camera.

21. The unmanned aerial vehicle controller according to claim 20, wherein determination to switch from a mode in which the first threshold is used to a mode in which the second threshold is used is made, when the user within the captured image captured during the selfie function is out of focus for a predetermined period of time.

22. The unmanned aerial vehicle controller according to claim 12, wherein determination to switch from a mode in which the first threshold is used to a mode in which the second threshold is used is made, when the drone does not move to an expected position within a predetermined period of time after starting the automatic driving for the selfie function.
